(19) United States
(12) Patent Application Publication
(10) Pub. No.: US 2007/0017818 A1
(43) Pub. Date: Jan. 25, 2007

(54) Solution for electrochemical mechanical polishing

(76) Inventors: Ismail Emesh, Gilbert, AZ (US); Bulent M. Basol, Manhattan Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/185,591

(22) Filed: Jul. 19, 2005

(51) Int. Cl. B23H 5/00

(52) U.S. Cl. 205/640

(57) ABSTRACT

A system and method for electropolishing a conductive surface of a wafer using an electrolyte comprising an electrically resistive agent that modulates the conductivity of the electrolyte. The electrically resistive agent is a urea or a urea derivative. The electrolyte may also include a chelating agent a pH adjusting agent, and/or a surface film forming agent. The system includes a wafer carrier configured to hold the wafer, a polishing pad, and an electrode in proximity to the polishing pad. The wafer carrier may be configured to rotate or laterally move the wafer on the polishing surface of the polishing pad.

### FIELD

The present invention generally relates to semiconductor integrated circuit technology and, more particularly, to electrolyte compositions for electropolishing or electroetching processes and apparatuses.

### BACKGROUND

Conventional semiconductor devices generally include a semiconductor substrate, usually a silicon substrate, and a plurality of sequentially formed dielectric layers and conductive paths or interconnects made of conductive materials. Interconnects are usually formed by filling a conductive material in trenches etched into the dielectric layers. In an integrated circuit, multiple levels of interconnect networks laterally extend with respect to the substrate surface. Interconnects formed in different layers can be electrically connected using vias or contacts.

The filling of a conductive material into features, such as vias, trenches, pads or contacts, can be carried out by techniques, such as electrochemical deposition or electroless deposition. In an electrodeposition or electroplating method, a conductive material, such as copper, is deposited over the substrate surface, including into such features. Copper is the material of choice for interconnect applications because of its low resistivity and good electromigration properties. After electrodeposition, a material removal technique is employed to planarize and remove the excess metal or overburden from the top surface, leaving conductors only in the features or cavities. This way a network of interconnect structures are formed on the wafer surface.

The standard material removal technique that is most commonly used for the purpose of planarization and overburden removal is chemical mechanical polishing (CMP). During a CMP process, a surface of a substrate is polished by a polishing pad in the presence of a chemical solution or slurry while a force is applied on the substrate to push the surface of the substrate against the polishing pad. Chemical etching and electropolishing (electroetching or electrochemical etching), and electrochemical mechanical polishing or electrochemical mechanical etching are also attractive process options for copper removal.

Electrochemical mechanical polishing (ECMP) planarizes non-planar copper surfaces by electrochemically forming and mechanically removing a surface film on a copper layer. The surface film is typically formed while polishing the substrate with a pad at a reduced force compared to the conventional CMP. A typical force of 0.1-0.6 psi is applied during ECMP, which makes ECMP attractive for polishing metal layers formed on mechanically weak insulators, such as ultra low-k insulators. In contrast, if the force applied during CMP is reduced to 0.1-0.6 psi, the rate of removal of the layers becomes low, which may be undesirable. During electropolishing (including ECMP), the electric current (rather than the force applied) determines the rate of removal. In ECMP technology, a copper-coated wafer is pressed against a polishing pad while feeding an electrolyte that contains a mixture of abrasive particles and chemicals, such as complexing or chelating agents, film forming agents, buffers and surfactants. An anodic potential is applied to the metal layer during ECMP with respect to an electrode, which is also wetted by the electrolyte.

Although much progress has been made in electropolishing approaches and apparatuses, there is still need for lower cost electrochemical removal techniques that uniformly planarize and remove excess conductive films from workpiece surfaces applying low cost and stable electrolytes and low force on the wafer surface and without causing damage and defects, especially on advanced wafers with ultra low-k or extreme low-k materials.

### SUMMARY

In accordance with an aspect of the invention, a system for electropolishing a conductive surface of a wafer is provided. The system comprises a wafer carrier configured to hold the wafer, a polishing pad, an electrode in proximity to the polishing pad, and an electrolyte. The polishing pad has a polishing surface, wherein the polishing surface is configured to contact the conductive surface. The electrolyte comprises an electrically resistive agent selected from the group consisting of urea and a urea derivative.

In accordance with another aspect of the invention, a method is provided of electropolishing a conductive surface of a wafer using a polishing pad, wherein the conductive surface has features formed therein. The conductive surface is contacted with a polishing surface of the pad and electrolyte is flowed onto the polishing surface while contacting the conductive surface with the polishing surface. The electrolyte comprises an electrically resistive agent selected from the group consisting of urea and urea derivatives.

In accordance with yet another aspect of the invention, a method is provided of forming an electrolyte. An acidic solution is provided and comprises an ion-free agent that is configured for polishing a conductive surface of a wafer using a polishing pad.

According to another embodiment, an electrolyte is provided for polishing a conductive surface of a wafer using a polishing pad. The electrolyte comprises an electrically resistive agent selected from the group consisting of urea and urea derivatives, wherein the electrically resistive agent is selected to act as a chelating agent.

According to yet another embodiment, an electrolyte composition is provided for electropolishing a conductive surface of a wafer using a polishing pad. The electrolyte composition comprises a chelating agent, a surface film forming agent, a pH adjusting agent, and an electrically resistive agent. The chelating agent is selected from the group consisting of citric acid and ammonium oxalate. The surface film forming agent is selected from the group consisting of BTA, methyl benzotriazole, and triazole. The pH adjusting agent is selected from the group consisting of KOH, NH₄OH, and trimethyl amine hydroxide, wherein the pH of the electrolyte is between 2 to 6. The electrically resistive agent is selected from the group consisting of urea, urea hydroxide, and urea oxalate.

According to another embodiment, a method is provided for electropolishing a conductive surface of a wafer using a polishing pad. The conductive surface is contacted with an electrolyte and a polishing surface of the polishing pad. The ion-free chelating agent may be selected from the group consisting of urea, urea derivatives, and soluble organic amines.

### BRIEF DESCRIPTION OF THE DRAWINGS

FIG. 1 is a cross-section of an exemplary substrate plated with conductive material.

FIG. 2 is a cross-section of the substrate of FIG. 1 after an electropolishing process, in accordance with an embodiment.

FIG. 3 is an exemplary electropolishing system according to an embodiment.

FIG. 4 illustrates a graph of a step height reduction during an electrochemical mechanical polishing process according to an embodiment.

### DETAILED DESCRIPTION

The preferred embodiments provide an electropolishing electrolyte or electropolishing solution to form a smooth and planar surface during electropolishing of metal layers. The electropolishing electrolyte may be an acidic solution including at least one chelating agent, at least one surface film forming agent, at least one pH adjusting agent and at least one electrically resistive agent.

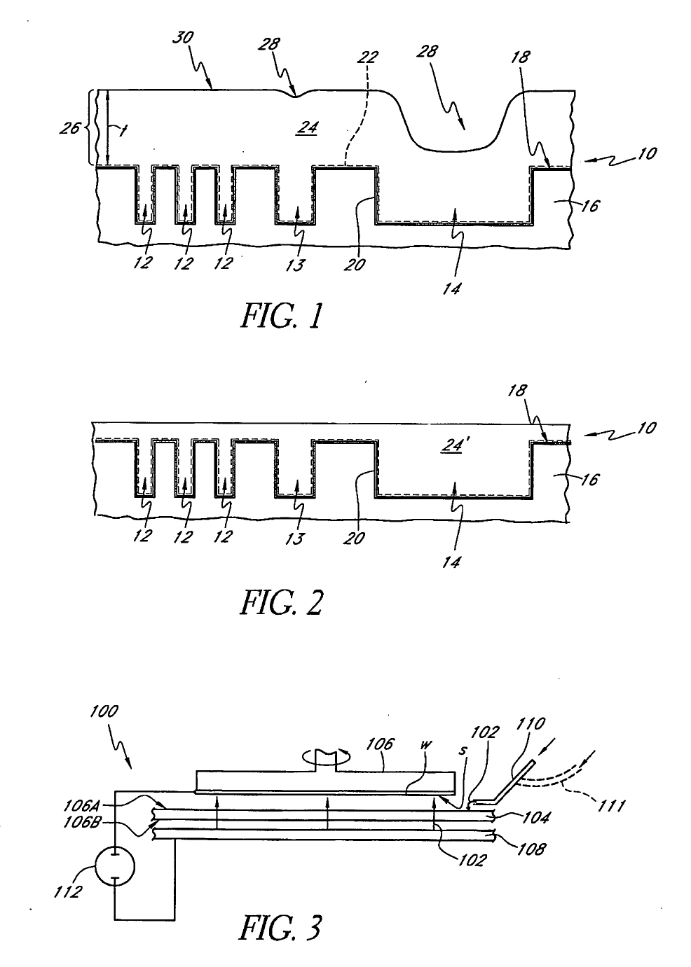

Use of the preferred electropolishing electrolyte will be exemplified by help of FIGS. 1-3. FIG. 1 shows an exemplary substrate 10 plated with copper, which will be electropolished using the electropolishing electrolyte. The substrate 10 includes small features 12, such as high aspect ratio trenches or vias; medium features 13, such as medium size trenches; and large features 14, such as large trenches. The features 12, 13, 14 are cavities formed in a dielectric layer 16. The substrate 10 may be an exemplary portion on a semiconductor wafer, such as a silicon wafer. The dielectric layer 16 has a top surface 18; the features 12, 13, 14 and the surface 18 of the dielectric layer 16 are coated with a barrier/glue or adhesion layer 20 and a copper seed layer 22. The barrier layer 20 may be made of Ta, TaN, WN, WCN or combinations of any other materials that are commonly used as barriers to copper deposition. The seed layer 22 is deposited over the barrier layer 20, although for specially designed, more conductive barrier layers there may not be a need for a seed layer. Copper is electrodeposited onto the seed layer from a suitable plating bath. such as an acid sulfate bath, to form a copper layer 24. The copper layer 24 fills the features 12, 13, 14 and forms a relatively thick excess copper portion 26 on the substrate, which has a non-flat topography, including steps or recesses 28. The excess copper 26 may have a thickness ‘t’ measured from a portion of the barrier layer 20 on the surface 18 to the top surface 30 of the copper layer 24. Excess copper 26 is electropolished or electroplanarized, using the preferred electrolyte to reduce the thickness ‘t’, preferably in a planar manner. FIG. 2 shows the planar copper layer 24′, which is formed by electropolishing the copper layer 24 shown in FIG. 1. During the electropolishing process, which is conducted using the preferred electrolyte, the thickness ‘t’ of the excess copper layer 26 is reduced down to a preferred thickness of approximately 0-200 nanometers (nm).

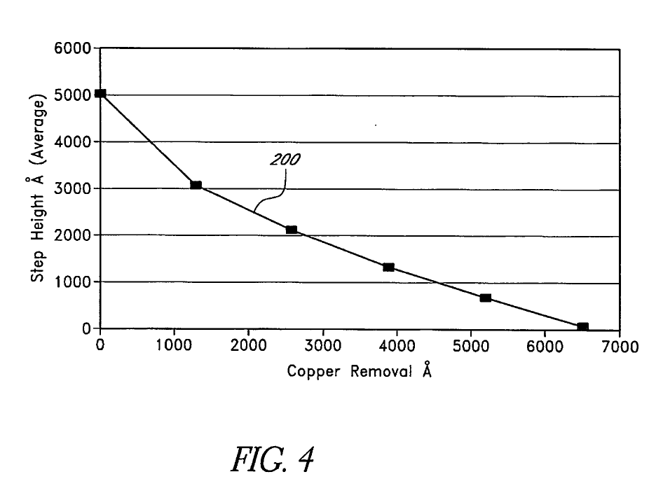

Electropolishing of the copper layer 24 may be performed using an exemplary electropolishing system 100 shown in FIG. 3. In the system 100, a conductive surface S of a wafer W is electropolished using a preferred electropolishing electrolyte 102 while physically contacting the conductive surface S with an electropolishing pad 104. The conductive surface S is defined by the copper layer 24 of the substrate 10 shown in FIG. 1. The wafer W is held by a wafer carrier 106, which may rotate and laterally move the wafer on the polishing pad 104 to planarize the conductive surface S. The electropolishing pad 104 may have a first surface 106A and a second surface 106B. The first surface 106A may polish the surface S of the wafer W during the process. The second surface 106B is placed on an electrode (cathode) 108 or near the electrode 108, as shown in FIG. 3. Alternatively, the electrode may be placed in the polishing pad 102 as a continuous or discontinuous electrode layer, such as a mesh electrode. The electropolishing pad 104 may include porosity or openings (not shown) that allow the electropolishing electrolyte 102 to contact the electrode 108 and the conductive surface S at the same time.

The electropolishing electrolyte 102 may be flowed through the electropolishing pad 104 or delivered onto it by an electrolyte line 110 of an electrode delivery mechanism (not shown). The polishing pad 104 may be rotated, moved in an orbital motion or moved laterally by a moving mechanism during the electropolishing process. Alternatively, the polishing pad may be belt-shaped to be moved linearly, for example bi-linearly or reciprocatingly by a moving mechanism to polish the surface S during the process. The electrode 108 of the system 100 is connected to a negative terminal of a power supply 112, and the conductive surface S is connected to a positive terminal of the power supply 112, using suitable electrical contacts. During the electropolishing process of the conductive surface S, a potential difference is applied between the conductive surface S and the electrode 108 while the electrode 108 and the conductive surface S is wetted by the electropolishing electrolyte 102 and while relative motion is established between the electropolishing pad 104 and the wafer W.

The electropolishing electrolyte 102 is an acidic solution that may include at least one of phosphoric acid, potassium phosphate and ammonium phosphate solutions. The electropolishing electrolyte preferably further comprises additive molecules, such as chelating agents, surface forming agents, complexing agents, pH adjusting agents and conductivity-modulating agents. In some cases, additives can serve dual roles, such as the illustrated conductivity modulating agents. An exemplary cheleating agent may be citric acid, ammonium citrate, oxalic acid or ammonium oxalate or any weak organic acid.

Significantly, the preferred electropolishing electrolyte includes a conductivity-modulating agent, preferably and ion-free agent that makes the solution more electrically resistive by its addition. In the illustrated embodiment, a complexing or chelating agent functions as an electrically resistive agent to modulate the conductivity of the electropolishing electrolyte. The electrolyte conductivity may also be adjusted by changing the acid concentration in the electrolyte. For example, increasing the concentration of the acid by fifty percent (50%) increases the conductivity by almost thirty percent (30%). This increase is particularly advantageous when the electrolyte is used to polish copper plated wafers at high current density. Increasing the conductivity decreases the potential, thus reducing undesirable chemical reactions on the copper surface, such as pitting and corrosion. However, as noted, an electrically resistive agent, such as urea and urea derivatives, can also be used as a complexing or chelating agent to facilitate the removal of the copper ions. In contrast, other chelating agents tend to generate ions and thus disadvantageously contriubte to conductivity.

An exemplary complexing or chelating agent which may function as an electrically resistive agent may be urea, urea oxalate, urea hydroxide, or a soluble organic amine. A surface forming agent in the electropolishing electrolyte 102 aids the planarization of the surface topography of the copper layer 24 shown in FIG. 1. Referring to FIG. 1, during the electropolishing process, the surface forming agent forms a protective surface layer, or passivation layer, in steps 28, thereby allowing the removal of copper only from the surface 30 of the copper layer 24, which is swept by the polishing pad 104. The passivation layer protects the steps 28 from the effect of acid in the electrolyte 102 and the polishing pad 104 removes the passivation layer from the surface 30 as the polishing pad 104 sweeps the surface 30. Benzotriazole (BTA) is the most commonly used reagent for the surface forming agent. However, BTA derivatives can also be added to the electropolishing electrolyte 102. The pH of the electrolyte 102 is adjusted to the desired value by adding KOH, NH₄OH, or trimethyl amine hydroxide. Preferably, the pH of the electrolyte 102 is in the range of about 2-6. A surfactant, such as phytic acid or sodium lauryl sulfate is added to decrease the friction between the surface S and the polishing pad 104 shown in FIG. 3. The electropolishing electrolyte 102 produces a smooth copper surface finish and excellent planarization while the pad 104 applies a low polishing force (0.1 to 0.6 psi) on the wafer W. Such low pressure ranges prevent defects from forming in the underlying dielectric layer.

As shown in FIG. 3, alternatively, an auxiliary delivery line 111 may deliver electrically resistive agent from an electrically resistive agent container (not shown) into the electrolyte line 110 and enables the electrically resistive agent to mix with the electrolyte. In other words, the electrolyte and the agent are mixed right before delivering this mixture to the surface of the wafer. By this way, the resistivity of the electrolyte may be in-situ controlled. Accordingly, such active delivery of electrically resistive agent, the current density, and therefore the resistivity of the electrolyte, can be changed during the process. The same is also true for the acidity of the electrolyte. If the acid content is used to control the resistivity of the electrolyte, acid can also delivered into the electrolyte line 110 from a separate acid line to mix it with the electrolyte. This also, in turn, provides in-situ resistivity control.

### EXAMPLE

An exemplary electropolishing electrolyte composition includes 2-20% H₃PO₄ by weight; 0.1-2% citric acid by weight; 0.5-2% urea by weight (as electrically resisitive agent); 0.1-0.6% BTA by weight; KOH to adjust the pH to 4-6; 0.1-1.0% colloidal silica by weight; 001-0.5% phytic acid or other surfactants. The size of the colloidal silica is prefrably between 20 nm to 150 nm. The electropolishing electrolyte of this embodiment produces smooth surfaces with high planarization efficiency, such as a planarization efficiency more than 95%, and low cost. The planarization effiency (P_{E}) is defined as:
P_{E}=1−(step-height after polishing/step-height before polishing)×100.

In an experiment, using a profilometer, the step height of an exemplary 100 μm×100 μm square area (or line array) was measured on a copper layer on a patterned wafer surface during electropolishing of the copper layer with the electropolishing electrolyte described. The step height measurements were taken at time intervals corresponding to a copper removal of approximately 100-150 nm. For example, if the step height of the structure (pre-ECMP step) is 500 nm and the step height post-ECMP is 50 nm, then the planarization effiency is about 90%. Curve 200 in graph in FIG. 4 illustrates the step height reduction during the ECMP process using the electrolyte described herein. Accordingly, the planarization effiency is more than 95% when about 600 nm of copper was removed.

Although various preferred embodiments and the best mode have been described in detail above, those skilled in the art will readily appreciate that many modifications of the exemplary embodiment are possible without materially departing from the novel teachings and advantages of this invention.

We claim:

1. A system for electropolishing a conductive surface of a wafer, comprising:
a wafer carrier configured to hold the wafer;
a polishing pad having a polishing surface, wherein the polishing surface is configured to contact the conductive surface;
an electrode in proximity to the polishing pad; and
an electrolyte comprising an electrically resistive agent selected from the group consisting of urea and urea derivatives.

2. The system of claim 1, wherein the electrically resistive agent is a chelating agent.

3. The system of claim 1, wherein the electrically resistive agent contains no ions.

4. The system of claim 1, wherein the wafer carrier is configured to rotate or laterally move the wafer on the polishing surface.

5. The system of claim 1, wherein the polishing pad includes at least one opening configured to allow the electrolyte to flow therethrough.

6. The system of claim 1, wherein the electrolyte further comprises at least one of phosphoric acid, potassium phosphate, and ammonium phosphate.

7. The system of claim 1, wherein the electrolyte further comprises a chelating agent selected from selected from the group consisting of citric acid and ammonium oxalate.

8. The system of claim 1, wherein the electrolyte further comprises a surface film forming agent comprising at least one of BTA, methyl benzotriazole and triazole.

9. The system of claim 8, wherein increasing the concentration of the BTA modifies the electrolyte to maintain planarization of the conductive surface at high current density.

10. The system of claim 1, wherein the electrolyte further comprises a pH adjusting agent selected from the group of KOH, NH₄OH, and trimethyl amine hydoxide, wherein the pH of the electrolyte is between 2 to 6.

11. The system of claim 1, wherein the electrolyte further comprises at least one of colloidal silica and abrasive particles.

12. The system of claim 1, wherein the electrolyte further includes an acid to modulate conductivity of the electrolyte.

13. A method of electropolishing a conductive surface of a wafer using a polishing pad, wherein the conductive surface has features formed therein, the method comprising:
contacting the conductive surface with a polishing surface of the pad; and
flowing electrolyte onto the polishing surface while contacting, wherein the electrolyte comprises an ion-free agent selected from the group consisting of urea and urea derivatives.

14. The method of claim 13, wherein the electrolyte further includes a chelating agent selected from the group consisting of citric acid and ammonium oxalate.

15. The method of claim 13, wherein the electrolyte further includes a surface film forming agent comprising at least one of BTA, methyl benzotriazole and traizole.

16. The method of claim 15, wherein increasing a concentration of the BTA modifies the electrolyte to maintain planarization of the conductive surface at high current density.

17. The method of claim 13, wherein the electrolyte further comprises a pH adjusting agent selected from the group of KOH, NH₄OH, and trimethyl amine hydoxide, wherein the pH of the electrolyte is between 2 to 6.

18. The method of claim 13, wherein the electrolyte further includes an acid to modulate conductivity of the electrolyte.

19. A method of forming an electrolyte, comprising providing an acidic solution, comprising an ion-free agent that is configured for polishing a conductive surface of a wafer using a polishing pad.

20. The method of claim 19, wherein the ion-free agent is selected from the group consisting of urea and urea derivatives.

21. The method of claim 19, further comprising combining a chelating agent to the acidic solution, wherein the chelating agent is selected from the group consisting of citric acid and ammonium oxalate.

22. The method of claim 19, further comprising combining a surface film forming agent with the acidic solution, wherein the surface film forming agent comprises at least one of BTA, methyl benzotriazole, and triazole.

23. An electrolyte for electropolishing a conductive surface of a wafer using a polishing pad, comprising:
an electrically resistive agent selected from the group consisting of urea and urea derivatives.

24. The electrolyte of claim 23, further including a chelating agent selected from the group consisting of citric acid and ammonium oxalate.

25. The electrolyte of claim 23, further including a surface film forming agent comprising at least one of BTA, methyl benzotriazole and triazole.

26. The electrolyte of claim 25, wherein increasing the concentration of the BTA modifies the electrolyte to maintain planarization of the conductive surface at high current density.

27. The electrolyte of claim 23, further including a pH adjusting agent selected from the group of KOH, NH₄OH, and trimethyl amine hydoxide, wherein the pH of the electrolyte is between 2 to 6.

28. The electrolyte of claim 23, further including at least one of colloidal silica and abrasive particles.

29. The electrolyte of claim 28, wherein a concentration of particles is between 0.1 to 1%.

30. The electrolyte of claim 28, wherein a size of the colloidal silica is between 20 to 100 nm.

31. The electrolyte of claim 23, further including an acid configured to modulate conductivity of the electrolyte.

32. The electrolyte of claim 23, wherein the polishing pad is configured to apply a pressure to the surface of the wafer in the range of 0.1 to 0.6 psi.

33. An electrolyte composition for electropolishing a conductive surface of a wafer using a polishing pad, comprising:
a chelating agent selected from the group consisting of citric acid and ammonium oxalate;
a surface film forming agent selected from the group consisting of BTA, methyl benzotriazole and triazole;
a pH adjusting agent selected from the group consisting of KOH, NH₄OH, and trimethyl amine hydoxide, wherein the pH of the electrolyte is between 2 to 6; and
an electrically resistive agent selected from the group consisting of urea, urea hydroxide, and urea oxalate.

34. The electrolyte composition of claim 33, further comprising at least one of colloidal silica and abrasive particles.

35. The electrolyte composition of claim 34, wherein a concentration of particles is between 0.1 to 1%.

36. The electrolyte composition of claim 34, wherein a size of the colloidal silica is between 20 to 100 nm.

37. The electrolyte composition of claim 33, wherein the electrically resistive agent contains no ions.

38. A method of electropolishing a conductive surface of a wafer using a polishing pad comprising:
contacting the conductive surface with an electrolyte and a polishing surface of the polishing pad; and
modulating conductivity of the electrolyte by changing the electrolyte concentration.

39. The method of claim 38, wherein the electrolyte comprises an ion-free chelating agent which is selected from the group consisting of urea, urea derivatives, and soluble organic amines.

40. The method of claim 38, wherein the electrolyte further includes a surface film forming agent comprising at least one of BTA, methyl benzotriazole and triazole.

41. The method of claim 40, wherein increasing a concentration of the BTA modifies the electrolyte to maintain planarization of the conductive surface at high current density.

42. The method of claim 38, wherein modulating conductivity comprises adding an ion-free chelating agent.
